(19) United States
(12) Patent Application Publication
(10) Pub. No.: US 2026/0312646 A1
(43) Pub. Date: Oct. 8, 2026

(54) TECHNOLOGIES FOR CHANNEL STATE INFORMATION AND BEAM PREDICTION

(71) Applicant: Apple Inc., Cupertino, CA (US)

(72) Inventors: Konstantinos Sarrigeorgidis, Los Gatos, CA (US); Xiang Chen, Campbell, CA (US); Jie Cui, San Jose, CA (US); Yang Tang, San Jose, CA (US); Manasa Raghavan, Sunnyvale, CA (US)

(73) Assignee: Apple Inc., Cupertino, CA (US)

(21) Appl. No.: 19/279,369

(22) Filed: Jul. 24, 2025

(30) Foreign Application Priority Data
Mar. 27, 2025 (GR) 20250100235

(51) Int. Cl. H04B 7/06; H04L 43/0805

(52) U.S. Cl. CPC H04B 7/0626; H04L 43/0805

(57) ABSTRACT

The present application relates to devices and components including apparatuses, systems, and methods for performance monitoring for channel state information (CSI) prediction. The present application further relates to devices and components including apparatuses, systems, and methods for beam alignment in continuous space.

### CROSS-REFERENCE TO RELATED APPLICATION

This application claims priority to Greek application No. 20250100235, entitled “Technologies for Channel State Information and Beam Prediction,” filed on Mar. 27, 2025, which is herein incorporated by reference in its entirety for all purposes.

### TECHNICAL FIELD

This application relates generally to communication networks and, in particular, to technologies associated with channel state information and/or beam prediction.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example of a user equipment (UE) with a channel state information (CSI) prediction model and a legacy CSI estimator, in accordance with some embodiments.

FIG. 3 illustrates an example procedure for performance monitoring, in accordance with some embodiments.

FIG. 4 illustrates an example radio resource control (RRC) configuration for monitoring a CSI prediction model, in accordance with some embodiments.

FIG. 5 illustrates an example of CSI-RS resources that may be configured, in accordance with some embodiments.

FIG. 6 illustrates an example procedure for network-side monitoring of a CSI prediction model, in accordance with some embodiments.

FIG. 7 illustrates an example of a beam prediction model in accordance with some embodiments.

FIG. 8 illustrates an example of a beam prediction model in accordance with some embodiments.

FIG. 9 illustrates a training environment in accordance with some embodiments.

FIG. 10 illustrates an example of deployment of the beam prediction model, in accordance with some embodiments.

FIG. 11 illustrates an operational flow/algorithmic structure in accordance with some embodiments.

FIG. 12 illustrates another operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

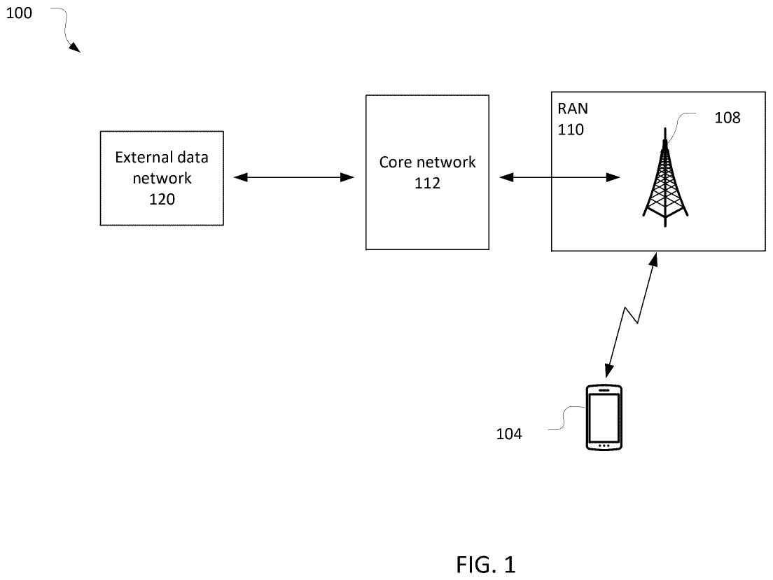

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane (UP) and control plane (CP) protocol terminations toward the UE 104.

The network environment 100 may further include a core network (CN) 112. For example, the CN 112 may comprise a 5th Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120, which may be accessed by the UE 104 via the RAN 110.

The UE 104 may generate channel state information (CSI) based on measurements on one or more reference signals transmitted by the RAN 110 (e.g., by the base station 108) and report the CSI to the RAN 110. The one or more reference signals may include, for example, a CSI-reference signal (CSI-RS) and/or a synchronization signal block (SSB, also referred to as a synchronization signal/physical broadcast channel (PBCH) block). The CSI may include, for example, a channel quality indicator (CQI), precoding matrix indicator (PMI), a CSI-RS resource indicator (CRI), a SSB resource indicator (SSBRI), layer indicator (LI), rank indicator (RI), layer 1 (L1) reference signal received power (RSRP), L1 signal-and-interference-to-noise ratio (SINR), a capability index, and/or time-domain properties.

In embodiments, the UE 104 may use an artificial intelligence (AI)/machine learning (ML) model (e.g., referred to as a CSI prediction model) to predict CSI. For example, the CSI prediction model may predict CSI at a second time (e.g., t+Δ) based on a CSI measurement at a first time (e.g., t), where the second time is after the first time. In some embodiments, the UE may obtain one or more CSI measurements in a measurement window and provide the CSI measurements to the CSI prediction model as input. The CSI prediction model may predict CSI associated with a future prediction window based on the one or more CSI measurements in the measurement window.

In embodiments, the CSI prediction model may be a UE-side model. For example, the UE 104 may implement and/or manage the CSI prediction model. The UE 104 may generate and transmit a CSI report that includes the predicted CSI.

The predicted CSI may enable the network to schedule a transmission (e.g., a downlink and/or uplink transmission) based on CSI that is more closely aligned in the time domain with a time of the transmission. Additionally, or alternatively, the predicted CSI may enable fewer CSI measurements to be performed, thereby saving time-frequency resources used for reference signals and/or saving power consumption of the UE 104.

The UE 104 and/or base station 108 may monitor performance of the CSI prediction model, e.g., based on one or more performance metrics (which may be referred to as key performance indicators (KPIs)). In some embodiments, the one or more performance metrics may be based on the predicted CSI and a measured CSI (referred to as ground truth CSI). The one or more performance metrics may include, for example, a normalized mean square error (NMSE), a squared generalized cosine similarity (SGCS), and/or another metric.

Different schemes for monitoring a UE-side CSI prediction model may be used. In a first scheme (which may be referred to as Type 1 monitoring), the UE 104 may calculate the one or more performance metrics and report them to the network. The network may determine whether an action is needed and/or the action to take based on the one or more performance metrics. For example, the action may include to fallback to legacy CSI measurements (e.g., without using the CSI prediction model), re-train the CSI prediction model, and/or switch to a different CSI prediction model. The network may configure one or more criteria (e.g., one or more thresholds) for the UE 104 to trigger performance monitoring and/or reporting of monitoring results.

In a second scheme (which may be referred to as Type 2 monitoring), the UE may report the predicted CSI and/or corresponding ground truth CSI. The network may calculate the one or more performance metrics based on the predicted CSI and/or corresponding ground truth. The network may further determine whether an action is needed and/or the action to take based on the one or more performance metrics.

Embodiments provide technologies for configuring and/or performing performance monitoring of a CSI prediction model, e.g., in accordance with Type 1 and/or Type 2 monitoring described above. While embodiments are described with respect to a UE-side model for CSI prediction, aspects of various embodiments may additionally or alternatively be applied to deployments that include a network-side model for CSI prediction.

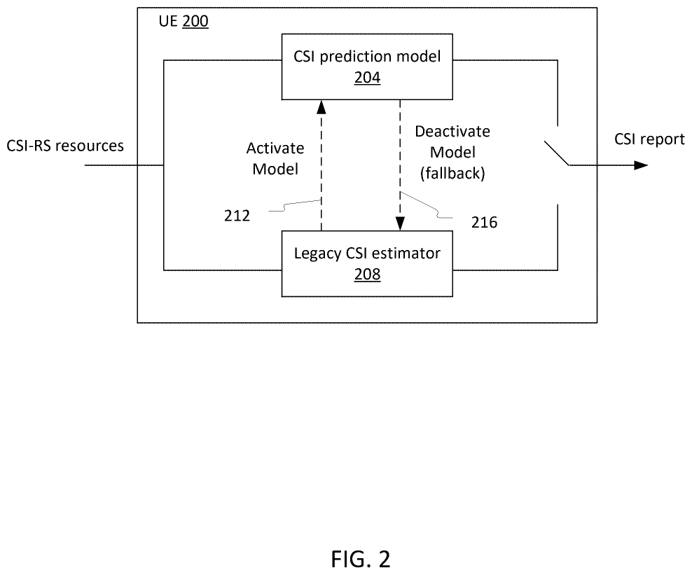

FIG. 2 illustrates an example of a UE 200 with a CSI prediction model (e.g., an AI/ML-based model) 204 and a legacy CSI estimator 208, in accordance with some embodiments. The UE 200 may receive a CSI-RS on respective CSI-RS resources. The CSI prediction model 204 may generate a predicted CSI based on the CSI-RS (e.g., based on measurements on the CSI-RS resources). The legacy CSI estimator 208 may generate an estimated CSI based on the CSI-RS (e.g., based on measurements on the CSI-RS resources).

The UE 200 may generate a CSI report, for transmission to the network, that includes the predicted CSI and/or the estimated CSI. As shown at 212, the UE 200 may activate the CSI prediction model 204, e.g., based on a configuration from the network and/or a trigger. When the CSI prediction model is activated, the CSI report may include the predicted CSI. Typically, the CSI report may not additionally include the estimated CSI, although in some instances the CSI report may include both the predicted CSI and the estimated CSI.

As shown at 216, the UE 200 may deactivate the CSI prediction model 204 and revert (e.g., fallback) to the legacy CSI estimation. The deactivation may be based on the performance monitoring of the CSI prediction model, as discussed herein. In fallback mode, the CSI report may include the estimated CSI.

As discussed above, performance monitoring may be used to evaluate whether the CSI prediction model 204 currently in use continues to meet expected performance standards. In embodiments, the performance monitoring may provide more than a binary indication of whether the model is functioning or not. For example, it may be desirable to identify situations when performance of the CSI prediction model has degraded to a noticeable but not yet catastrophic level, such as a 5-10% decline in performance. Detecting smaller degrees of degradation may provide the network with more information and/or an earlier indication of potential failure, thereby enabling more flexibility in network decisions and/or more timely corrective actions.

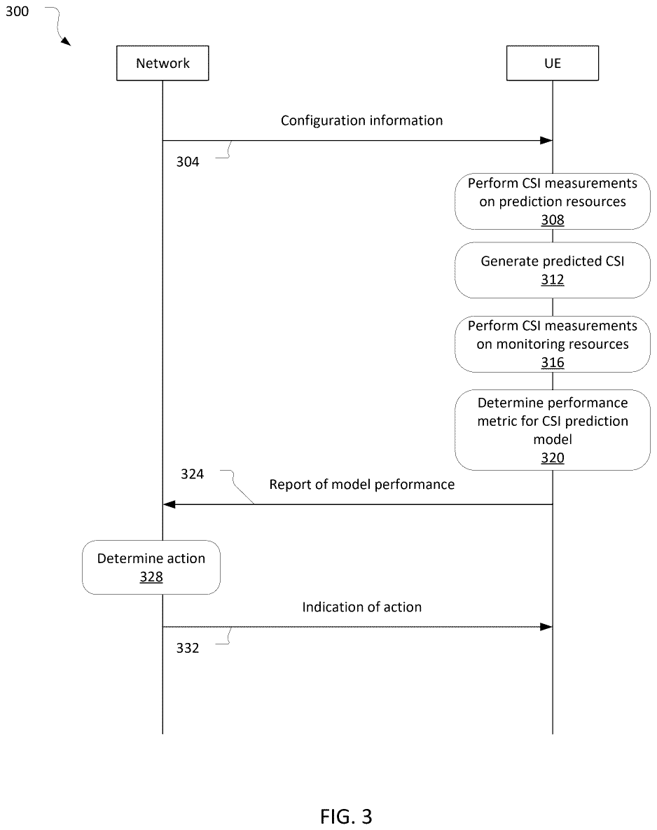

FIG. 3 illustrates an example procedure 300 for performance monitoring, in accordance with some embodiments. Aspects of the procedure 300 may be performed by a UE (e.g., UE 104) and/or a network (e.g., base station 108), or components thereof. The procedure 300 may be used in embodiments in which the UE determines the one or more performance metrics for evaluating performance of the CSI prediction model (e.g., Type 1 monitoring).

At 304 of the procedure 300, the UE may receive configuration information from the network to configure performance monitoring of a CSI prediction model. For example, the configuration information may be received via radio resource control (RRC) signaling.

In an example, the configuration information may indicate one or more thresholds associated with performance monitoring of the CSI prediction model. For example, the one or more thresholds may be used to trigger a report to the network and/or indicate in the report that a fallback action is needed (e.g., to revert to legacy CSI estimation). The one or more thresholds may include, for example, an NMSE threshold (e.g., NMSE<10%) and/or an SGCS threshold (e.g., SGCS>0.7).

The one or more thresholds may be dynamically configured by the network. For example, the network may have knowledge of (e.g., may receive and/or determine) one or more communication metrics associated with communication by the UE with the network, such as one or more throughput metrics, a cell load, a UE mobility, and/or historical performance (e.g., by the UE and/or other UEs). Accordingly, the network may determine whether and/or to what extent a degradation in a performance metric of the CSI prediction model is correlated with a degradation in the one or more communication metrics. The network may adjust the one or more thresholds used for performance monitoring based on the associated degradation in the one or more communication metrics.

In embodiments, the configuration information may additionally or alternatively indicate monitoring resources used for performance monitoring. The monitoring resources may correspond to CSI-RS resources in which the UE is to perform CSI measurements to generate the ground truth CSI. The monitoring resources may be in a prediction window to which a predicted CSI corresponds.

In some embodiments, the monitoring resources may be dedicated CSI-RS resources used for monitoring the CSI prediction model. For example, the UE may receive a separate configuration of CSI-RS resources (e.g., referred to as prediction resources) on which the UE is to perform CSI measurements that are used by the CSI prediction model to generate predicted CSI. The prediction resources may be configured in the same message (e.g., RRC message) that configures the monitoring resources and/or a different message (e.g., another RRC message).

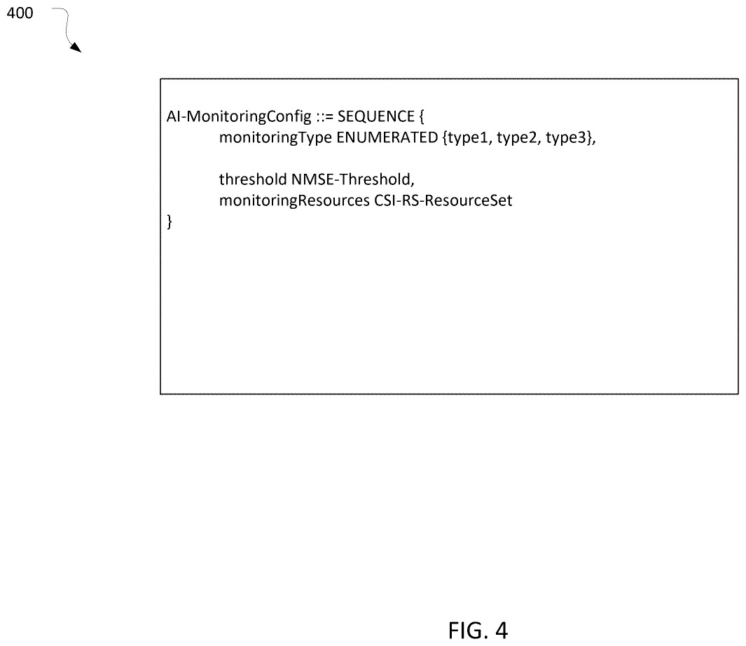

FIG. 4 illustrates an example RRC configuration 400 for monitoring a CSI prediction model, in accordance with some embodiments. As shown, the RRC configuration 400 may include an information element AI-MonitoringConfig that includes parameters, such as a monitoring type (e.g., Type 1, Type 2, Type 3, etc.), a threshold (e.g., an NMSE threshold, as shown, and/or a SGCS threshold), and a monitoring resource set.

In some embodiments, the configuration information may indicate a reporting configuration for the UE to report the performance monitoring results. For example, the reporting configuration may indicate a reporting resource (e.g., a time-frequency resource) in which the UE is to transmit the report. The resource may be periodic, semi-persistent, or aperiodic (e.g., triggered by request from the network, such as in a downlink control information (DCI)). In some embodiments, the report may be triggered based on the performance metric of the CSI prediction model exceeding a threshold, e.g., as described above. The configuration information may indicate reporting occasions in which the UE may transmit a report if triggered and/or other timing information (e.g., a timing offset from an associated monitoring resource and/or prediction window) that may be used by the UE to determine a time resource in which to transmit the report.

Returning to FIG. 3, at 308 of the procedure 300, the UE may perform one or more CSI measurements on the configured prediction resources. At 312 of the procedure 300, the UE may generate a predicted CSI based on the one or more CSI measurements. The predicted CSI may be generated using the CSI prediction model (e.g., an AI/ML model).

At 316 of the procedure 300, the UE may perform one or more CSI measurements on the configured monitoring resources. At 320 of the procedure 300, the UE may determine (e.g., calculate) a performance metric for the CSI prediction model. The performance metric may be determined based on the predicted CSI (e.g., generated at 312) and the CSI measurements on the monitoring resources (e.g., obtained at 316). For example, the performance metric may include an NMSE and/or an SGCS.

In an example, the SGCS may correspond to:

$$p ( W , {W}^{′} ) = \frac{1}{\vert W \vert {N}_{sb}} {\sum }_{i = 1}^{\vert W \vert} {\sum }_{k = 1}^{{N}_{sb}} {( \frac{‖ {w}_{k , i}^{H} {w}_{k , i}^{′} ‖ 2}{‖ {w}_{k , i} ‖ 2 ‖ {w}_{k , i}^{′} ‖ 2} )}^{2}$$

where W corresponds to the vector of measured CSI, W′ corresponds to the vector of predicted CSI, and/or N_{sb} corresponds to a number of subbands associated with the CSI.

At 324 of the procedure 300, the UE may generate a report of model performance based on the performance metric and transmit the report to the network. In some embodiments, the report may indicate a value (e.g., a quantized value) of the performance metric. For example, the report may include a field with multiple bits to indicate that the value of the performance metric is in one of a plurality of ranges of values. In other embodiments, the report may include a single bit to indicate whether the performance metric has exceeded a threshold. For example, the report may include a 1-bit flag in the header of the report. The threshold may be configured by the network, as further described herein.

In some embodiments, the report at 324 may correspond to a CSI report that also includes CSI feedback. The CSI feedback may include the predicted CSI and/or the one or more CSI measurements on the monitoring resources.

In some embodiments, the UE may transmit the report to the network based on a triggering event. For example, the triggering event may include that the performance metric has exceeded a threshold (e.g., the same threshold that is used to indicate the value of the performance metric or a different threshold), a request received by the UE from the network, and/or another event.

At 328 of the procedure 300, the network may determine an action to take based on the report. For example, the network may determine to deactivate the CSI prediction model (e.g., and fallback to legacy CSI estimation), re-train the CSI prediction model, and/or switch to another CSI prediction model. In another example, the network may determine to adjust one or more thresholds used for the monitoring report (e.g., the threshold that may be used to trigger transmission of the report and/or the indication in the report that the performance metric has exceeded the threshold). Accordingly, the UE may update the one or more thresholds and continue using the CSI prediction model. For example, the network may adjust the one or more thresholds based on one or more communication metrics associated with communication by the UE (e.g., one or more throughput metrics, a cell load, a UE mobility, and/or historical performance of the UE and/or other UEs). In an example, the network may relax a threshold (which may include increasing or decreasing the threshold depending on the corresponding performance metric) if the one or more QoS metrics indicate that the performance of the CSI prediction model is not significantly affecting the communication performance of the UE. In another example, the network may make the threshold more stringent (e.g., decrease or increase the threshold) based on the QoS metrics indicating a significant effect of the CSI prediction model on communication performance of the UE.

In some instances, the network may determine to keep using the existing CSI prediction model without further action (e.g., continue using the same threshold).

At 332 of the procedure 300, the network may transmit an indication of the action to the UE. For example, the network may transmit a message (e.g., a MAC CE) with a 1-bit flag to deactivate or activate a CSI prediction model. In another example, the network may transmit a RRC reconfiguration message to the UE that indicates a different CSI reporting mode (e.g., legacy CSI estimation) and/or indicates one or more different thresholds associated with performance monitoring of the CSI prediction model.

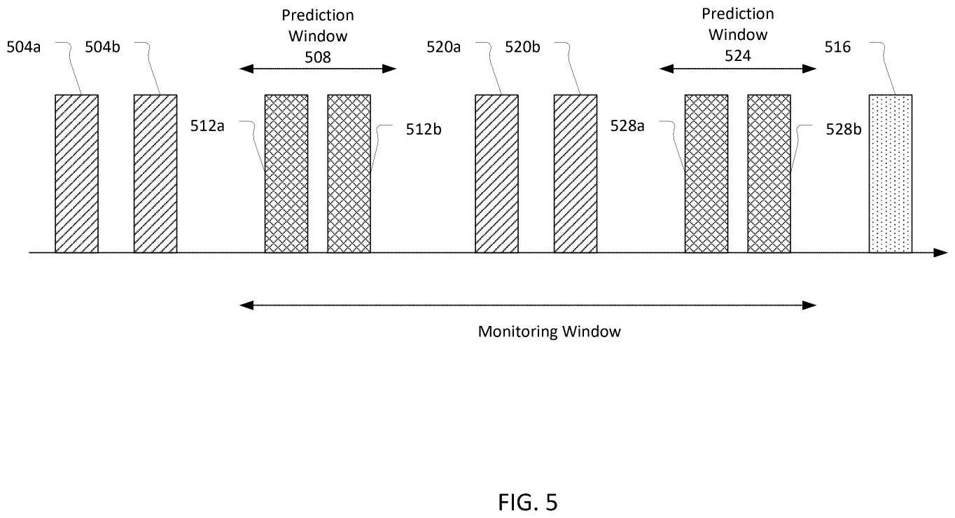

FIG. 5 illustrates an example of CSI-RS resources that may be configured, in accordance with some embodiments. As shown, one or more prediction resources 504a-b may be configured, and may be used by the UE to generate a predicted CSI associated with a prediction window 508 (e.g., which is later in time than the prediction resources 504a-b). The predicted CSI may be generated using a CSI prediction model (e.g., an AI/ML model).

One or more monitoring resources 512a-b may be configured within the prediction window 508. The UE may generate one or more CSI measurements based on the one or more monitoring resources 512a-b. For Type 1 monitoring, the UE may calculate a performance metric based on the predicted CSI and the one or more CSI measurements. The UE may report monitoring results in a reporting resource 516.

In some embodiments, the report may be based on evaluation of multiple CSI predictions for respective prediction windows. For example, FIG. 5 illustrates additional prediction resources 520a-b that may be used to generate a predicted CSI associated with a prediction window 524. One or more monitoring resources 528a-b may be configured within the prediction window 524. The UE may calculate the performance metric based further on the predicted CSI for the prediction window 524 and the one or more CSI measurements on the monitoring resources 528a-b. For example, the reported performance metric may correspond to an average of performance metrics associated with the respective prediction windows 508 and 524. In another example, the report may include separate performance metrics for respective prediction windows 508 and 524.

The prediction resources (e.g., prediction resources 504a-b and/or 520a-b) and/or the monitoring resources (e.g., monitoring resources 512a-b and/or 528a-b) may be configured as periodic, semi-persistent, and/or aperiodic resources. In some embodiments, the monitoring resources may have a different scheduling type than the prediction resources. For example, the prediction resources may be periodic or semi-persistent resources, and the monitoring resources may be aperiodic resources (e.g., triggered by the network, such as via DCI). This may enable the network to dynamically trigger the performance monitoring, such as based on communication metrics and/or other network information.

In another example, the monitoring resources may be configured with a different periodicity and/or other parameter (e.g., number/density of resources in a corresponding window) than the prediction resources, such as a longer periodicity than the prediction resources.

While FIG. 5 illustrates monitoring resources that are separate from the prediction resources, in other embodiments, some or all of the CSI-RS resources configured as prediction resources may also be used for monitoring the CSI prediction model. For example, a CSI-RS resource may be used to predict CSI at a future time and also to evaluate a prior prediction.

As discussed above, in some embodiments (e.g., with Type 2 monitoring) the network may perform the monitoring of CSI prediction performance, e.g., including calculation of the one or more performance metrics. In this case, the UE may report predicted CSI (e.g., generated by the CSI prediction model) and measured CSI (e.g., measured on the monitoring resources) to the network so that the network can calculate the one or more performance metrics.

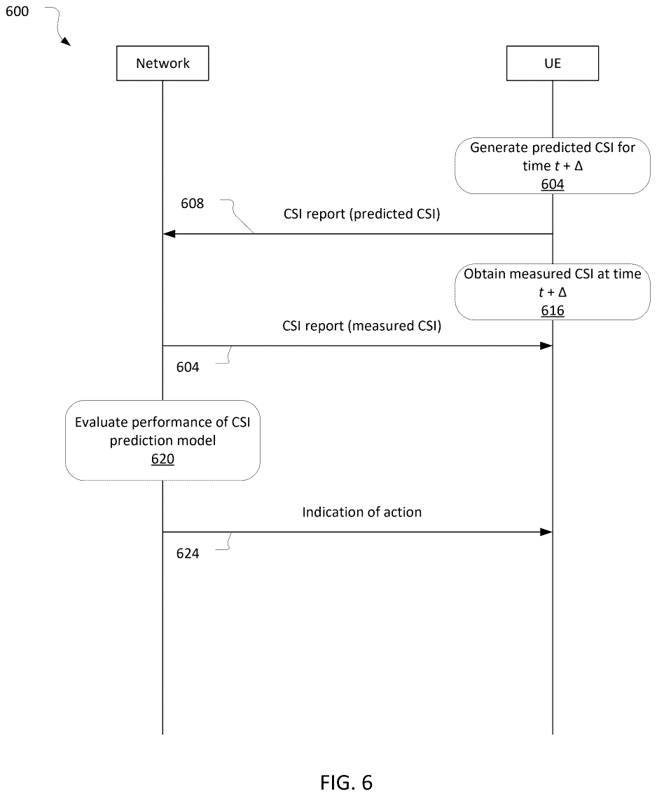

FIG. 6 illustrates an example procedure 600 for network-side monitoring of a CSI prediction model, in accordance with some embodiments. Aspects of the procedure 600 may be performed by a UE (e.g., UE 104) and/or a network (e.g., base station 108), or components thereof.

At 604 of the procedure 600, the UE may generate a predicted CSI for time t+Δ. The time t may be a reference time that may correspond to a time at which the CSI prediction is performed, a time at which the predicted CSI is reported, or a time of a CSI-RS resource based on which the predicted CSI is generated.

At 608, the UE may transmit a CSI report to the network to indicate the predicted CSI.

At 612, the UE may obtain a measured CSI at time t+Δ (e.g., within a corresponding prediction window). At 616, the UE may transmit a CSI report to the network to indicate the measured CSI. The measured CSI may correspond to ground truth CSI for monitoring performance of the CSI prediction model.

At 620, the network may evaluate performance of the CSI prediction model based on the predicted CSI and the measured CSI. For example, the network may calculate one or more performance metrics (e.g., NMSE and/or SGCS) based on a comparison of the predicted CSI and the measured CSI. The network may determine whether to take one or more actions based on the one or more performance metrics.

At 624, the network may transmit a message to the UE to indicate an action to take. For example, the action may be to deactivate the CSI prediction model, fallback to legacy CSI estimation, re-train the CSI prediction model, and/or switch to another CSI prediction model (e.g., deactivate a first model and activate a second model).

The procedure 600 may provide more flexibility for the network in evaluating performance of the CSI prediction model and/or determining one or more actions to take based on the evaluation. However, as shown in FIG. 6, the procedure 600 may require the UE to transmit the measured CSI to the network to act as ground truth CSI.

Embodiments herein may further relate to beam management using a beam prediction model (e.g., an AI/ML-based model) to predict one or more beams (e.g., transmit beams and/or receive beams). In an example, the beam prediction model may receive beam measurements for a first set of beams as an input and may output beam information for a second set of beams. The beam measurements may include, for example, a reference signal received power (RSRP), a reference signal received quality (RSRQ), and/or another suitable measurement. The measurements may be performed on respective reference signals, such as SSBs and/or CSI-RSs.

The second set of beams may include additional beams not included in the first set of beams. The second set of beams may or may not be defined to include the first set of beams. Individual beams of the first set and/or second set may correspond to a transmit beam, a receive beam, and/or a pair of transmit beam and receive beam. In an example, the output beam information may include predicted beam measurements for the second set of beams (e.g., for the beams that are not included in the first set of beams). In another example, the output beam information may include a ranking of some or all of the second set of beams (which may be defined to include the first set of beams in this case). For example, the ranking may indicate the top K beams, where K is an integer of one or more. When the output beam information includes the ranked beams, the output beam information may or may not also include predicted beam measurements corresponding to the ranked beams.

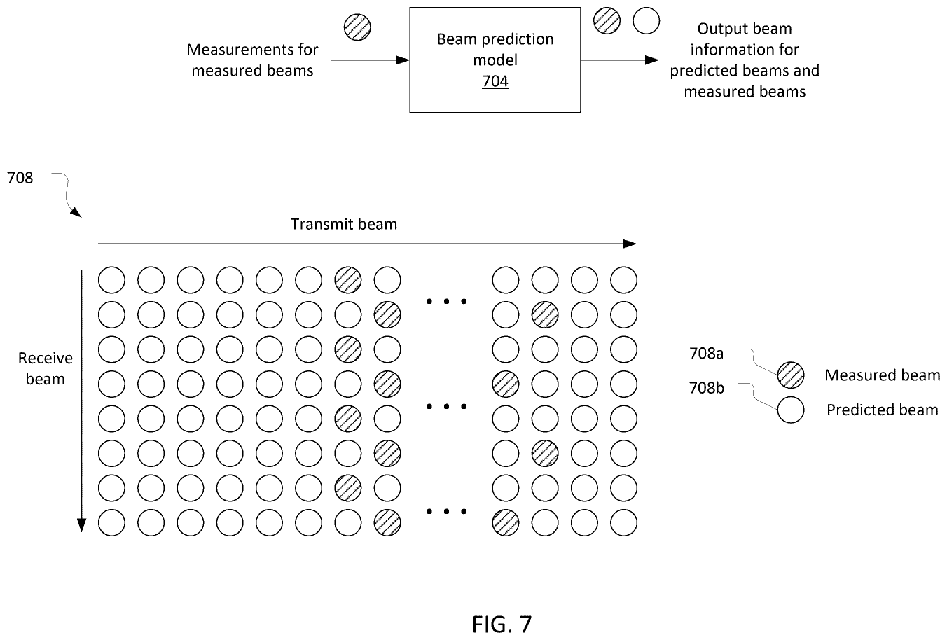

FIG. 7 illustrates an example of a beam prediction model 704 in accordance with some embodiments. The example of FIG. 7 is illustrated with respect to beam selection for a DL transmission, e.g., to select a transmit beam to be used by the base station and/or a receive beam to be used by the UE. For example, FIG. 7 illustrates a plurality of beams 708, with individual beams 708 associated with a transmit beam and a receive beam (which may collectively be referred to as a beam pair). The beams 708 may include a subset of beams 708a that are measured by the UE. The measurements on beams 708a may be provided as an input to the beam prediction model 704. The beam prediction model 704 may generate output beam information for the beams 708, including for beams 708b that are not included in the input. As discussed above, the output beam information may include predicted beam measurements and/or predicted beam rankings (e.g., a set of the best K predicted beams, which may be ranked in order of quality). The beam prediction model may enable reduced signaling overhead for reference signals and/or measurements.

Current schemes for beam management based on a beam prediction model are codebook-based. For example, the spatial prediction may assume a pre-specified transmit beam subset (from a transmit codebook) that is being swept during reference signal transmission. Additionally, a receive beam subset (from a receive codebook) may be used at the UE to sense the beamformed channel. Accordingly, the beams of the first set of beams (e.g., including beams 708a) and/or the second set of beams (e.g., including beams 708b) may be associated with a transmit beam and/or a receive beam from a respective codebook.

For example, in current schemes, the beam management model may be trained using a labeled dataset. The labeled dataset may correspond to {X, Y}, where X is the RSRP of a beam subset and Y is the RSRP of the full codebook.

Additionally, maximum ratio transmission (MRT) may be effective under the unit power constraint and/or equal gain transmission (EGT) may be effective under the unit modulus constraint. However, these techniques may require full CSI, which may not be available during beam alignment. Even with full CSI, finding the optimal EGT and/or equal gain combining (EGC) beams may require a grid search over codebook entries.

Furthermore, in non-line of sight (NLOS) environments, the optimum transmitting and combining vectors may be given by the right and left singular vector of the channel matrix. Performance loss may be incurred if these vectors are approximated by a grid search over the codebooks.

Accordingly, selecting beams from a codebook for beam alignment may lead to performance loss.

Various embodiments herein provide mechanisms for non-codebook based beam prediction. For example, embodiments include mechanisms for beam prediction to compute beams (e.g., a transmit beam and/or receive beam) from continuous space in the spatial domain.

Additionally, embodiments may include techniques to train a beam prediction model using a training dataset with unlabeled data. Accordingly, the beam prediction model may be used for beam alignment with unsupervised learning.

In an example, a set of parameters that may be determined (e.g., optimized) by the beam prediction model may include one or more of: a set of pilot transmit beams, denoted by V; a set of pilot receive beams, denoted by W; an optimum transmit beam, denoted by g_{TX}; and/or an optimum receive beam, denoted by g_{RX}. The optimum transmit beam g_{TX} may be determined by a first generator function G₁, e.g., g_{TX}=G₁(z(V, W)), where z (V, W) corresponds to measurements on pilot beams V and W. The optimum receive beam g_{TX} may be determined by a second generator function G₂, e.g., g_{TX}=G₂(z (V, W)).

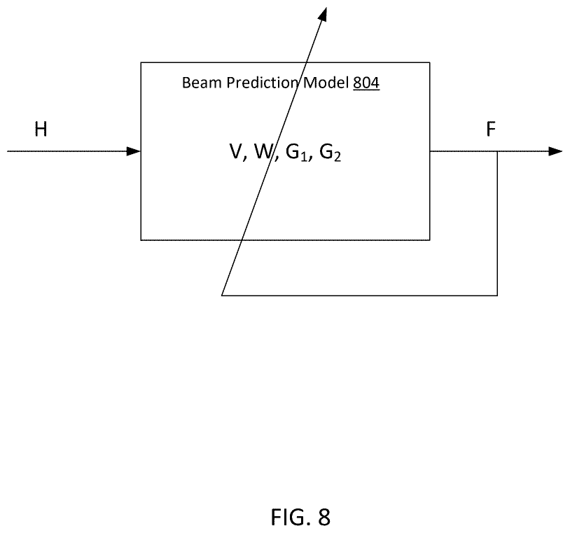

FIG. 8 illustrates an example of a beam prediction model 804 in accordance with some embodiments. A set of channel measurements H may be obtained (e.g., by the UE and/or network) that represent the full multiple input, multiple output (MIMO) channel. The set of channel measurements H may be provided to the beam prediction model 804 as an input. The beam prediction model 804 may optimize V, W, G₁, and G₂, e.g., to optimize a performance metric F.

In an example, the UE may be equipped with M=MₕMᵥ antenna ports and the base station may be equipped with N=MₕMᵥ antennas. For example, the M antenna ports may correspond to Mₕ×Mᵥ antenna ports, where Mₕ and Mᵥ correspond to antenna ports in the horizontal and vertical directions, respectively. The N antennas may correspond to to Nₕ×Nᵥ antennas, where Nₕ and Nᵥ correspond to antennas in the horizontal and vertical directions, respectively.

Accordingly, the channel H may be of dimension M×N. The set of pilot receive beams W may correspond to the sensing pilot codebook of receiver codewords, e.g.:

$$W ∈ {ℂ}^{M \times {M}_{s}}$$

where [symbol] denotes a set of complex numbers and Mₛ denotes pilot receive (sensing) beams.

The set of pilot transmit beams V may correspond to the pilot codebook of transmitter codewords, e.g.:

$$V ∈ {ℂ}^{N \times {N}_{s}}$$

where Ns denotes pilot transmit beams

Based on all the transmit and receive codewords, the matrix for the set of measurements may be:

$$Y = {W}^{H} HVX + {W}^{H} n \\ where Y ∈ {ℂ}^{{M}_{s} \times {N}_{s}} and X = [ \begin{matrix}{x}_{1} & & \\ & ⋯ & \\ & & {x}_{{N}_{s}}\end{matrix} ]$$

The above equation for the set of measurements may be rewritten as:

$$Y = {H}^{b} X + N$$

where H^{b} ∈ [symbol] ^{M}^{ₛ}^{×N}^{ₛ} is the beam space channel (in beam space).

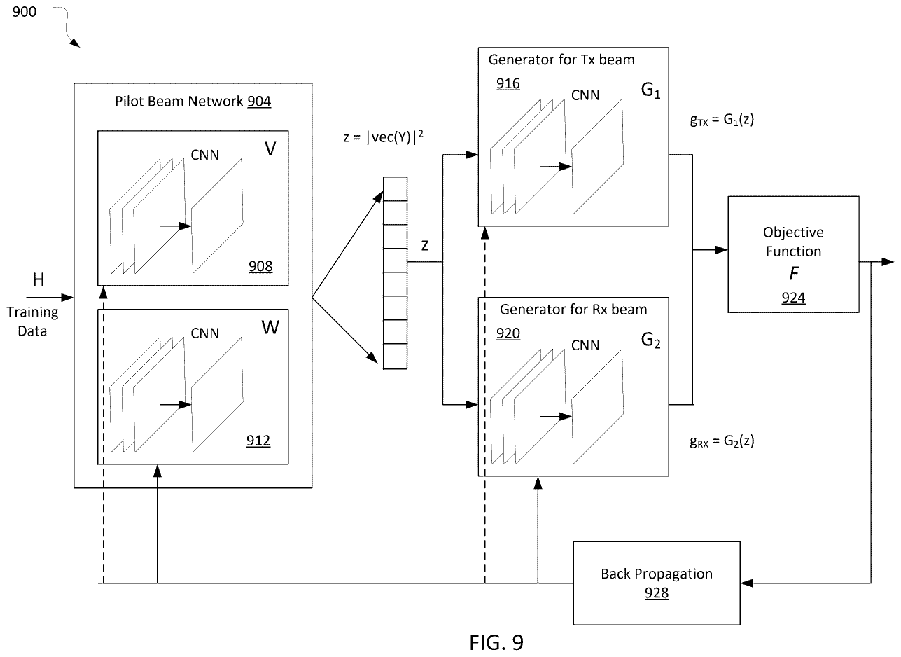

FIG. 9 illustrates a training environment 900 in accordance with some embodiments. The training environment 900 may be implemented at the network, the UE, and/or an external entity (e.g., server) outside of the network.

As shown, training data H may be input to a pilot beam network 904. The pilot beam network 904 may include a pilot transmit beam network 908 and a pilot receive beam network 912. The pilot transmit beam network 908 and/or pilot receive beam network 912 may include respective neural networks, such as convolutional neural networks (CNNs). The training data H may include data obtained via a statistical model and/or real data. The training data H may be associated with a cell site in which the beam prediction model is to be deployed.

The pilot transmit beam network 908 may generate a set of pilot transmit beams V, and the pilot receive beam network 912 may generate a set of pilot receive beams W. In an example, the pilot transmit beams V and/or pilot receive beams W may be generated from continuous space in the spatial domain (e.g., not selected from a codebook). The pilot beam network 904 may generate a set of measurements z based on the pilot transmit beams V and pilot receive beams W (e.g. via sweeping the pilot beams V and W). In an example, the set of measurements z may correspond to |vec(Y)|².

The set of measurements z may be passed to a transmit beam generator 916 and a receive beam generator 920. The transmit beam generator 916 and/or receive beam generator 920 may include respective neural networks, such as CNNs. The transmit beam generator 916 may determine (e.g., train) a first generator function G₁ to generate a transmit beam g_{TX} (e.g., an optimum transmit beam) based on the set of measurements z. The receive beam generator 920 may determine (e.g., train) a second generator function G₂ to generate a receive beam g_{RX} (e.g., an optimum receive beam) based on the set of measurements z. In an example, the transmit beam g_{TX} and/or receive beam g_{RX} generated from continuous space in the spatial domain (e.g., not selected from a codebook).

An objective function block 924 may receive one or more input parameters associated with the training, such as the generated transmit beam g_{TX}, the first generator function G₁, the generated receive beam g_{RX}, the second generator function G₂, and/or the set of measurements z. The objective function block 924 may apply an objective function to the one or more input parameters and generate an objective output. The objective output may be indicative of a desired performance characteristic (e.g., throughput and/or other characteristic).

The objective output may be fed back to the pilot transmit beam network 908, the pilot receive beam network 912, the transmit beam generator 916, and/or the receive beam generator 920 (e.g., via back propagation block 928). For example, the back propagation block 928 may adjust one or more weights of the pilot transmit beam network 908, pilot receive beam network 912, transmit beam generator 916, and/or receive beam generator 920 based on an output of the objective function block 924. For example, the back propagation block 928 may calculate one or more gradients (e.g., derivatives) of the AI/ML models and adapt the corresponding weights based on the one or more gradients and the output of the objective function block 924. The adjustments may alter the output of the objection function block 924, and the back propagation block 928 may make further adjustments in an iterative process (e.g., to optimize the output of the objective function block 924).

Accordingly, the pilot transmit beam network 908, the pilot receive beam network 912, the transmit beam generator 916, and/or the receive beam generator 920 may adjust (e.g., optimize) their respective outputs based on the feedback from the objective function block 924. Thus, V, W, G₁, and G₂ may be collectively trained, e.g., to optimize the output of the objective function.

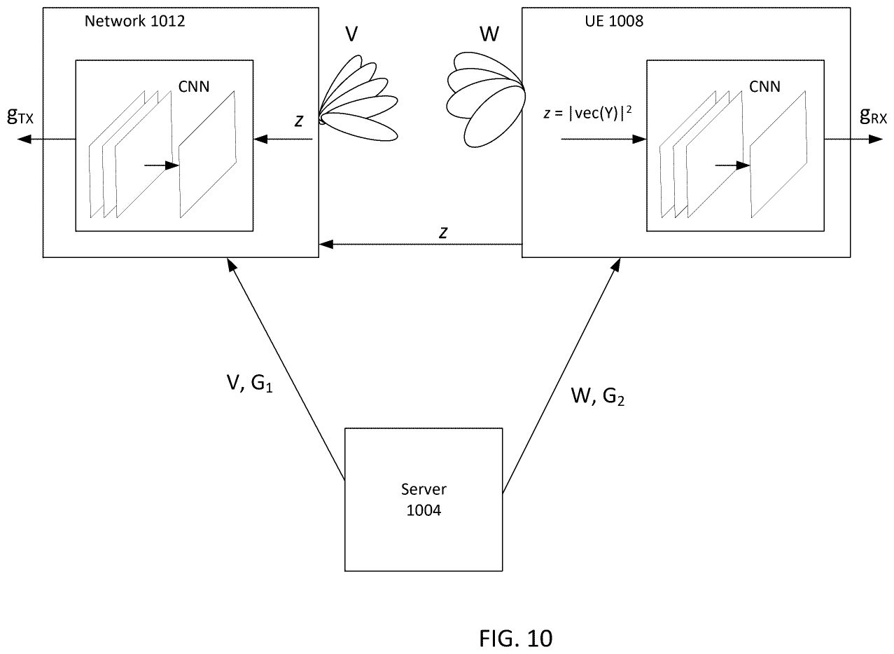

FIG. 10 illustrates an example of deployment of the beam prediction model, in accordance with some embodiments. In the example of FIG. 10, the beam prediction model is trained at a server 1004 (e.g., in accordance with FIG. 9) and then deployed at a UE 1008 and/or network 1012. The server 1004 may transmit the trained pilot transmit beams V and/or trained generator function G₁ to the network 1012. The server 1004 may transmit the trained pilot receive beams W and/or trained generator function G₂ to the UE 1008.

The network 1012 may sweep the pilot transmit beams V for transmission of a reference signal (e.g., SSB and/or CSI-RS). The UE 1008 may sweep the pilot receive beams W to receive the reference signal and generate measurements z. The UE 1008 may use the trained generator function G₁ to generate a receive beam g_{RX} (e.g., optimized receive beam) to use for receiving a downlink transmission from the network 1012.

The UE 1008 may transmit the measurements z to the network 1012 (e.g., in a measurement report). The network 1012 may use the trained generator function G₂ to generate a transmit beam g_{TX} (e.g., optimized transmit beam) to use for transmitting the downlink transmission to the UE 1008. The network 1012 may transmit the downlink transmission (e.g., a physical downlink shared channel (PDSCH) and/or physical downlink control channel (PDCCH)) to the UE 1008 using the transmit beam g_{TX}. The UE 1008 may use the receive beam g_{TX} to receive the downlink transmission.

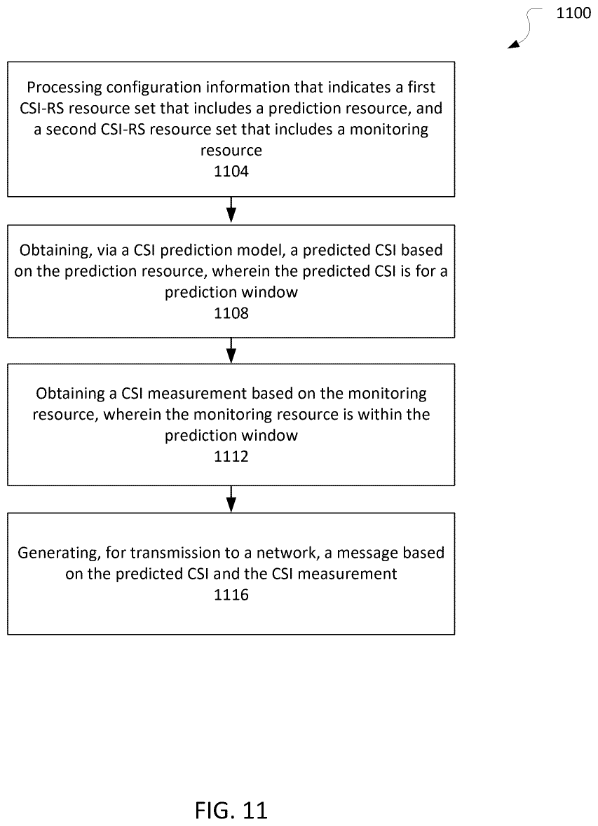

FIG. 11 illustrates an operational flow/algorithmic structure 1100 in accordance with some embodiments. In some embodiments, the operational flow/algorithmic structure 1100 may be implemented by a UE such as, for example, UE 104, UE 1400, or components thereof, for example, processors 1404A.

The operational flow/algorithmic structure 1100 may include, at 1104, processing configuration information that indicates a first CSI-RS resource set that includes a prediction resource, and a second CSI-RS resource set that includes a monitoring resource. In an example, the second CSI-RS resource set has a longer periodicity than the first CSI-RS resource set. The first and second CSI-RS resource sets may be respective configured as periodic, semi-persistent, or aperiodic. In some embodiments, the first and second CSI-RS resource sets may be configured with different scheduling types. For example, the first CSI-RS resource set may be configured as periodic or semi-persistent and the second CSI-RS resource set may be configured as aperiodic

The operational flow/algorithmic structure 1100 may further include, at 1108, obtaining, via a CSI prediction model, a predicted CSI based on the prediction resource, wherein the predicted CSI is for a prediction window.

The operational flow/algorithmic structure 1100 may further include, at 1112, obtaining a CSI measurement based on the monitoring resource, wherein the monitoring resource is within the prediction window.

The operational flow/algorithmic structure 1100 may further include, at 1116, generating, for transmission to a network, a message based on the predicted CSI and the CSI measurement.

In some embodiments, the UE may determine a performance metric based on the predicted CSI and the CSI measurement. For example, the performance metric may include an NMSE and/or an SGCS.

In an example, the configuration information may indicate a performance threshold, and the message may include an indication that the performance metric exceeds the performance threshold. For example, the indication may be a single bit to indicate that the performance metric exceeds the performance threshold or may include multiple bits to indicate a value of the performance metric. In some embodiments, the UE may receive, from the network, a reconfiguration to update a value of the performance threshold.

In another example, the message may include the predicted CSI and the CSI measurement.

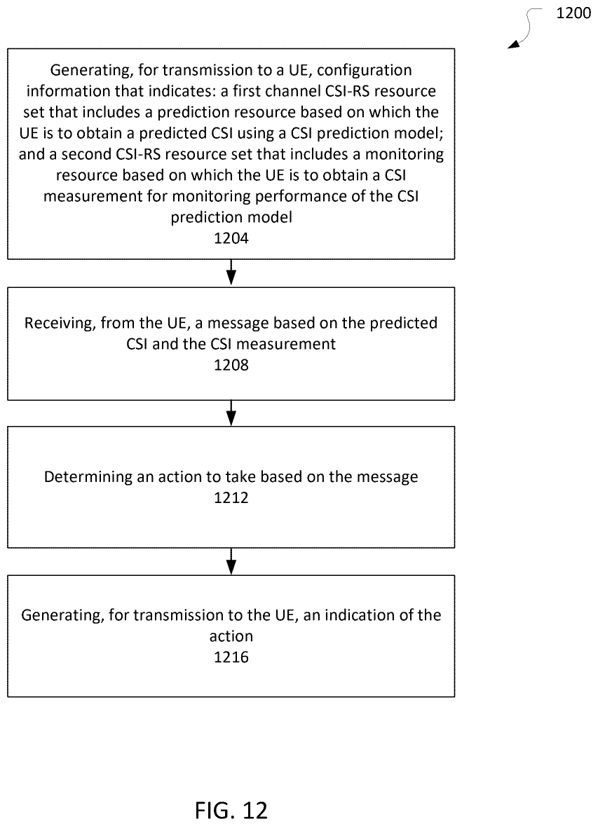

FIG. 12 illustrates another operational flow/algorithmic structure 1200 in accordance with some embodiments. In some embodiments, the operational flow/algorithmic structure 1200 may be implemented by a network device such as, for example, a device of RAN 110 (e.g., base station 108), network device 1400, or components thereof, for example, processors 1404A.

The operational flow/algorithmic structure 1200 may include, at 1204, generating, for transmission to a UE, configuration information that indicates: a first channel CSI-RS resource set that includes a prediction resource based on which the UE is to obtain a predicted CSI using a CSI prediction model; and a second CSI-RS resource set that includes a monitoring resource based on which the UE is to obtain a CSI measurement for monitoring performance of the CSI prediction model.

The operational flow/algorithmic structure 1200 may further include, at 1208, receiving, from the UE, a message based on the predicted CSI and the CSI measurement. In an example, the configuration information may indicate a performance threshold for a performance metric based on the predicted CSI and the CSI measurement. The message from the UE may indicate that the performance metric exceeds the performance threshold. For example, the indication may be a single bit or may include multiple bits to indicate a value of the performance metric.

In another example, the message may include the predicted CSI and the CSI measurement. The network device may determine a performance metric based on the predicted CSI and the CSI measurement.

The operational flow/algorithmic structure 1200 may further include, at 1212, determining an action to take based on the message. For example, the action may be determined based on the indication of the performance metric in the message or based on the performance metric generated based on the predicted CSI and the CSI measurement.

The operational flow/algorithmic structure 1200 may further include, at 1216, generating, for transmission to the UE, an indication of the action.

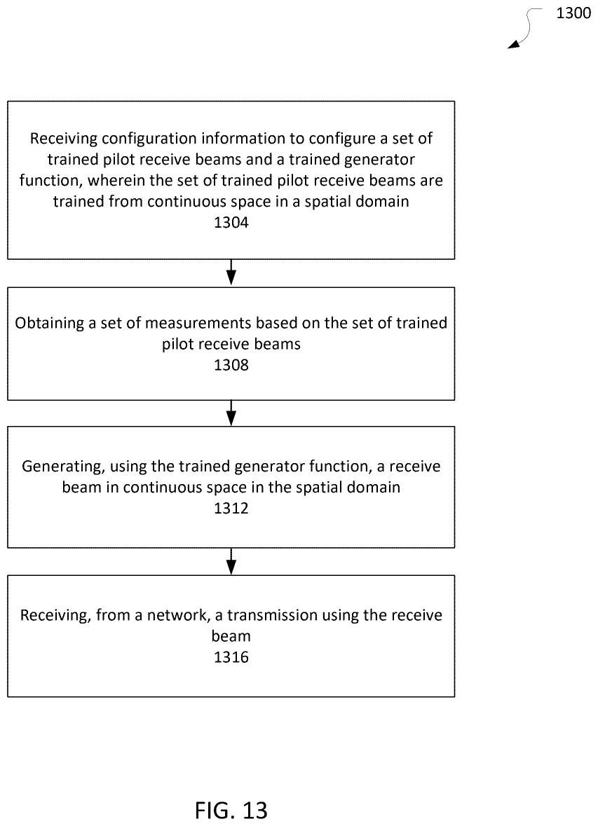

FIG. 13 illustrates another operational flow/algorithmic structure 1300 in accordance with some embodiments. In some embodiments, the operational flow/algorithmic structure 1300 may be implemented by a UE such as, for example, UE 104, UE 1400, or components thereof, for example, processors 1404A.

The operational flow/algorithmic structure 1300 may include, at 1304, receiving configuration information to configure a set of trained pilot receive beams and a trained generator function, wherein the set of trained pilot receive beams are trained from continuous space in a spatial domain. For example, the configuration information may be received from a network (e.g., a base station or a device of a core network) or a server that trains a beam prediction model.

The operational flow/algorithmic structure 1300 may further include, at 1308, obtaining a set of measurements based on the set of trained pilot receive beams. In an example, the set of measurements may be obtained on one or more reference signals swept with a set of trained pilot transmit beams that are trained in continuous space.

The operational flow/algorithmic structure 1300 may further include, at 1312, generating, using the trained generator function, a receive beam in continuous space in the spatial domain. In an example, the trained generator function may be trained based on the set of trained pilot receive beams.

The operational flow/algorithmic structure 1300 may further include, at 1316, receiving, from a network, a transmission using the receive beam.

In an example, the UE may transmit a report to the network that indicates the set of measurements. The network may generate, using another trained generator function, a transmit beam in continuous space based on the set of measurements.

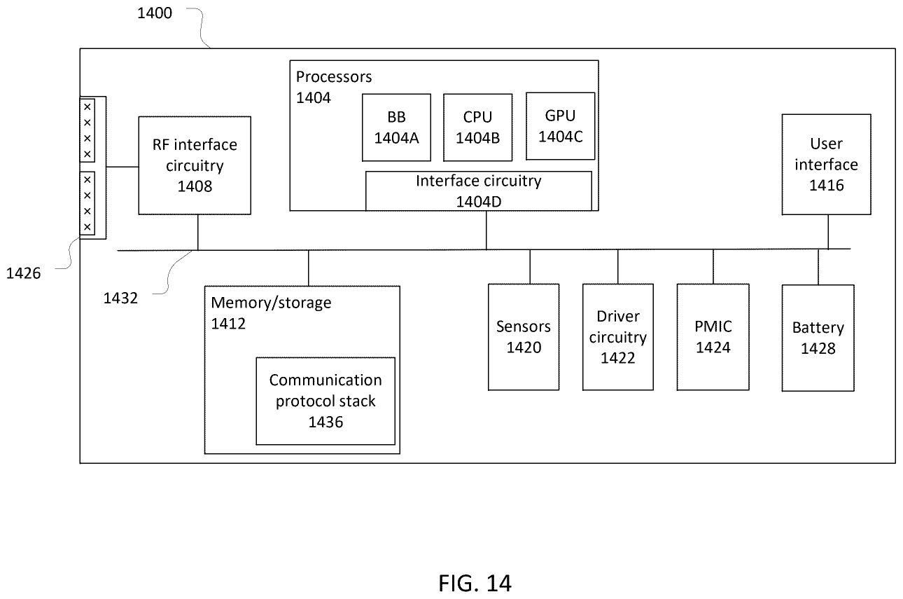

FIG. 14 illustrates a UE 1400 in accordance with some embodiments. The UE 1400 may be similar to and substantially interchangeable with UE 104.

The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein (e.g., operations associated with event detection for CSI compression). The processors 1404 may also include interface circuitry 1404D to enable communication by, for example, communicatively coupling the processor circuitry with one or more other components of the UE 1400.

In some embodiments, the baseband processor 1404A may access a communication protocol stack 1436 in the memory/storage 1412 to communicate over a 3GPP compatible network. In general, the baseband processor 1404A may access the communication protocol stack 1436 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform operations as described herein (e.g., operations associated with event detection for CSI compression).

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

A battery 1428 may power the UE 1400, although in some examples the UE 1400 may be mounted deployed in a fixed location and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

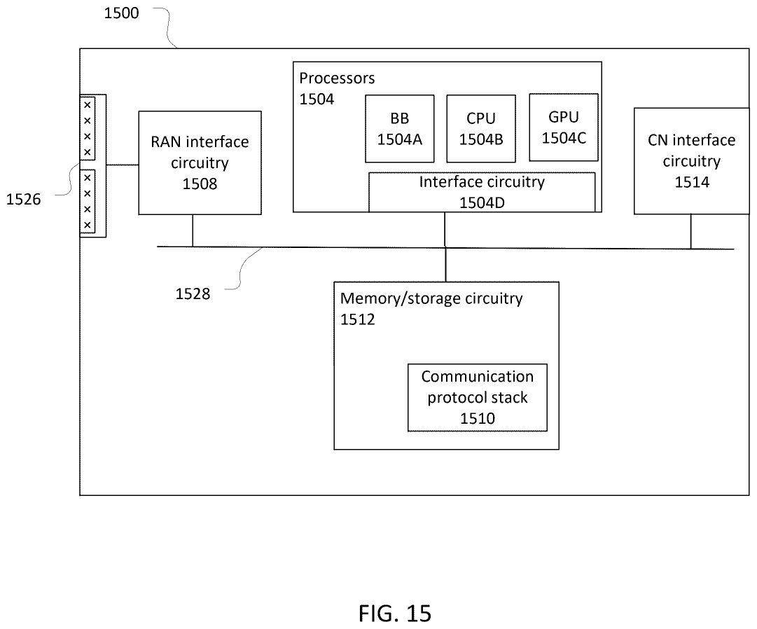

FIG. 15 illustrates a network device 1500 in accordance with some embodiments. The network device 1500 may be similar to, and substantially interchangeable with, the base station 108 and/or a component of the CN 112.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the network device 1500 to perform operations as described herein (e.g., operations associated with event detection for CSI compression). The processors 1504 may also include interface circuitry 1504D to communicatively couple the processor circuitry with one or more other components of the network device 1500.

The CN interface circuitry 1514 may provide connectivity to a core network, for example, a 5th Generation Core network (5GC) using a 5GC-compatible network interface protocol such as carrier Ethernet protocols, or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

The following sections provide further exemplary embodiments are provided.

Example 1 includes a method comprising: processing configuration information that indicates a first channel state information (CSI)-reference signal (CSI-RS) resource set that includes a prediction resource, and a second CSI-RS resource set that includes a monitoring resource; obtaining, via a CSI prediction model, a predicted CSI based on the prediction resource, wherein the predicted CSI is for a prediction window; obtaining a CSI measurement based on the monitoring resource, wherein the monitoring resource is within the prediction window; and generating, for transmission to a network, a message based on the predicted CSI and the CSI measurement.

Example 2 includes the method of example 1, wherein the configuration information further indicates a performance threshold, and wherein the method further comprises: determining a performance metric based on the predicted CSI and the CSI measurement; and determining that the performance metric exceeds the performance threshold, wherein generating the message includes generating the message to include an indication that the performance metric exceeds the performance threshold.

Example 3 includes the method of example 2, wherein the indication is a single bit.

Example 4 includes the method of example 2, wherein the indication includes multiple bits to indicate a value of the performance metric.

Example 5 includes the method of example 2, wherein the performance metric includes a normalized mean square error (NMSE) or a squared generalized cosine similarity (SGCS).

Example 6 includes the method of example 2, further comprising receiving, from the network, a reconfiguration to update a value of the performance threshold.

Example 7 includes the method of example 1, wherein the message includes the predicted CSI and the CSI measurement.

Example 8 includes the method of example 1, wherein the second CSI-RS resource set has a longer periodicity than the first CSI-RS resource set.

Example 9 includes the method of example 1, wherein the first CSI-RS resource set is configured as periodic or semi-persistent and the second CSI-RS resource set is configured as aperiodic.

Example 10 includes the method of example 1, further comprising receiving, from the network, an indication to deactivate the CSI prediction model.

Example 11 includes a method comprising: generating, for transmission to a user equipment (UE), configuration information that indicates: a first channel state information (CSI)—reference signal (CSI-RS) resource set that includes a prediction resource based on which the UE is to obtain a predicted CSI using a CSI prediction model; and a second CSI-RS resource set that includes a monitoring resource based on which the UE is to obtain a CSI measurement for monitoring performance of the CSI prediction model; receiving, from the UE, a message based on the predicted CSI and the CSI measurement; determining an action to take based on the message; and generating, for transmission to the UE, an indication of the action.

Example 12 includes the method of example 11, wherein the configuration information further indicates a performance threshold, wherein the message indicates that a performance metric exceeds the performance threshold, and wherein the performance metric is based on the predicted CSI and the CSI measurement.

Example 13 includes the method of example 12, wherein the indication is a single bit or includes multiple bits to indicate a value of the performance metric.

Example 14 includes the method of example 12, wherein determining the action includes determining an updated performance threshold based on the message and one or more communication metrics, and wherein the indication of the action includes an indication of the updated performance threshold.

Example 15 includes the method of example 11, wherein the message includes the predicted CSI and the CSI measurement, and wherein the method further comprises: determining a performance metric based on the predicted CSI and the CSI measurement; and determining the action based on the performance metric.

Example 16 includes the method of example 11, wherein the second CSI-RS resource set has a longer periodicity than the first CSI-RS resource set.

Example 17 includes the method of example 11, wherein the first CSI-RS resource set is configured as periodic or semi-persistent and the second CSI-RS resource set is configured as aperiodic.

Example 18 includes the method of example 11, wherein the action includes to deactivate the CSI prediction model and fallback to a legacy CSI estimation procedure.

Example 19 includes processing circuitry to: process configuration information to identify a performance threshold; obtain, via a channel state information (CSI) prediction model, a predicted CSI for a prediction window; obtain a CSI measurement associated with the prediction window; determine a performance metric based on the predicted CSI and the CSI measurement; identify that the performance metric exceeds the performance threshold; and generate, for transmission to a network, a message to indicate that the performance metric exceeds the performance threshold.

Example 20 includes the processing circuitry of example 19, wherein the message includes: a single bit to indicate that the performance metric exceeds the performance threshold; or multiple bits to indicate a value of the performance metric.

Example 21 includes the processing circuitry of example 19, wherein the processing circuitry is further to receive, from the network, a message to update a value of the performance metric.

Example 22 includes a method comprising: receiving configuration information to configure a set of trained pilot receive beams and a trained generator function, wherein the set of trained pilot receive beams are trained from continuous space in a spatial domain; obtaining a set of measurements based on the set of trained pilot receive beams; generating, using the trained generator function, a receive beam in continuous space in the spatial domain; and receiving, from a network, a transmission using the receive beam.

Example 23 includes the method of example 22, wherein the set of measurements are obtained on one or more reference signals swept with a set of trained pilot transmit beams that are trained in continuous space.

Example 24 includes the method of example 22, wherein the trained generator function is a first generator function, and wherein the method further comprises generating, for transmission to the network, a report to indicate the set of measurements, wherein the transmission is to be transmitted using a transmit beam generated in continuous space by a second trained generator function based on the set of measurements.

Example 25 includes the method of example 22, wherein the trained generator function is trained based on the set of trained pilot receive beams.

Another example may include an apparatus comprising means to perform one or more elements of a method described in or related to any of examples 1-25, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Another example may include an apparatus comprising logic, modules, or circuitry to perform one or more elements of a method described in or related to any of examples 1-25, or any other method or process described herein.

Another example may include a method, technique, or process as described in or related to any of examples 1-25, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-25, or portions thereof.

Another example may include a signal as described in or related to any of examples 1-25, or portions or parts thereof.

Another example may include a datagram, information element, packet, frame, segment, PDU, or message as described in or related to any of examples 1-25, or portions or parts thereof, or otherwise described in the present disclosure.

Another example may include a signal encoded with data as described in or related to any of examples 1-25, or portions or parts thereof, or otherwise described in the present disclosure.

Another example may include a signal encoded with a datagram, IE, packet, frame, segment, PDU, or message as described in or related to any of examples 1-25, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Another example may include a computer program comprising instructions, wherein execution of the program by a processing element is to cause the processing element to carry out the method, techniques, or process as described in or related to any of examples 1-25, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing configuration information that indicates a first channel state information (CSI)—reference signal (CSI-RS) resource set that includes a prediction resource, and a second CSI-RS resource set that includes a monitoring resource;
obtaining, via a CSI prediction model, a predicted CSI based on the prediction resource, wherein the predicted CSI is for a prediction window;
obtaining a CSI measurement based on the monitoring resource, wherein the monitoring resource is within the prediction window; and
generating, for transmission to a network, a message based on the predicted CSI and the CSI measurement.

2. The method of claim 1, wherein the configuration information further indicates a performance threshold, and wherein the method further comprises:
determining a performance metric based on the predicted CSI and the CSI measurement; and
determining that the performance metric exceeds the performance threshold, wherein generating the message includes generating the message to include an indication that the performance metric exceeds the performance threshold.

3. The method of claim 2, wherein the indication is a single bit.

4. The method of claim 2, wherein the indication includes multiple bits to indicate a value of the performance metric.

5. The method of claim 2, wherein the performance metric includes a normalized mean square error (NMSE) or a squared generalized cosine similarity (SGCS).

6. The method of claim 2, further comprising receiving, from the network, a reconfiguration to update a value of the performance threshold.

7. The method of claim 1, wherein the message includes the predicted CSI and the CSI measurement.

8. The method of claim 1, wherein the second CSI-RS resource set has a longer periodicity than the first CSI-RS resource set.

9. The method of claim 1, wherein the first CSI-RS resource set is configured as periodic or semi-persistent and the second CSI-RS resource set is configured as aperiodic.

10. A method comprising:
generating, for transmission to a user equipment (UE), configuration information that indicates:
a first channel state information (CSI)-reference signal (CSI-RS) resource set that includes a prediction resource based on which the UE is to obtain a predicted CSI using a CSI prediction model; and
a second CSI-RS resource set that includes a monitoring resource based on which the UE is to obtain a CSI measurement for monitoring performance of the CSI prediction model;
receiving, from the UE, a message based on the predicted CSI and the CSI measurement;
determining an action to take based on the message; and
generating, for transmission to the UE, an indication of the action.

11. The method of claim 10, wherein the configuration information further indicates a performance threshold, wherein the message indicates that a performance metric exceeds the performance threshold, and wherein the performance metric is based on the predicted CSI and the CSI measurement.

12. The method of claim 11, wherein the indication is a single bit or includes multiple bits to indicate a value of the performance metric.

13. The method of claim 11, wherein determining the action includes determining an updated performance threshold based on the message and one or more communication metrics, and wherein the indication of the action includes an indication of the updated performance threshold.

14. The method of claim 10, wherein the message includes the predicted CSI and the CSI measurement, and wherein the method further comprises:
determining a performance metric based on the predicted CSI and the CSI measurement; and
determining the action based on the performance metric.

15. The method of claim 10, wherein the second CSI-RS resource set has a longer periodicity than the first CSI-RS resource set.

16. The method of claim 10, wherein the first CSI-RS resource set is configured as periodic or semi-persistent and the second CSI-RS resource set is configured as aperiodic.

17. The method of claim 10, wherein the action includes to deactivate the CSI prediction model and fallback to a legacy CSI estimation procedure.

18. An apparatus comprising:
processing circuitry to:
process configuration information to identify a performance threshold;
obtain, via a channel state information (CSI) prediction model, a predicted CSI for a prediction window;
obtain a CSI measurement associated with the prediction window;
determine a performance metric based on the predicted CSI and the CSI measurement;
identify that the performance metric exceeds the performance threshold; and
generate, for transmission to a network, a message to indicate that the performance metric exceeds the performance threshold; and
interface circuitry coupled to the processing circuitry to enable communication.

19. The apparatus of claim 18, wherein the message includes:
a single bit to indicate that the performance metric exceeds the performance threshold; or
multiple bits to indicate a value of the performance metric.

20. The apparatus of claim 18, wherein the processing circuitry is further to receive, from the network, a message to update a value of the performance threshold.
